(19) United States
(12) Patent Application Publication
(10) Pub. No.: US 2025/0371591 A1
(43) Pub. Date: Dec. 4, 2025

(54) Machine-Learning Detection of Seasonal Items from a Catalog Database Maintained by an Online System

(71) Applicant: Maplebear Inc., San Francisco, CA (US)

(72) Inventors: Brent Scheibelhut, Toronto (CA); Charles Wesley, San Diego, CA (US)

(21) Appl. No.: 18/677,183

(22) Filed: May 29, 2024

(51) Int. Cl. G06Q 30/0601

(52) U.S. Cl. CPC G06Q 30/0603

(57) ABSTRACT

A trained model detects seasonal items in an item catalog database of an online system. Upon acquiring item data with information about an item in the item catalog database, the online system applies the trained model to output, based on the item data, a seasonality score for the item that is indicative of a predicted seasonality of the item, and to identify a season associated with the item. The online system updates the item catalog database by adding an identification of the identified season to an entry of the item in the item catalog database. The online system further generates, based on the seasonality score and the identified season, action data associated with one or more actions in relation to the item. The online system communicates, to a computing system of a retailer, the action data prompting the one or more actions in relation to the item.

### BACKGROUND

An online system, such as an online concierge system, maintains a database with a catalog of items that are offered for sale by retailers associated with the online system. The retailers have many items that they stock all year long, but then the retailers also have other items that are seasonal and tied to specific holidays or occasions, such as heart-shaped chocolate boxes for Valentine's Day, turkey-themed decorations for Thanksgiving, tinsel and ornaments for Christmas, etc. The seasonal items can be items offered year-round, but for whom demand spikes around a holiday, e.g., mini eggs that sell year-round but particularly during Easter. Also, the seasonal items can be items that are consigned to the clearance bin the moment a holiday is over, such as themed Halloween candy or Halloween/Christmas decorations.

It frequently takes additional effort to merchandise the seasonal items online, as the seasonal items are not easily identifiable (i.e., they span a wide range of taxonomy categories). And retailers can eat the cost when they have not sold all of their seasonal inventory by the holiday and have to clear it out at a steep discount. The ideal scenario for a retailer would be to sell all their seasonal merchandise right as the holiday arrives, without actually turning any interested buyers away. Hence, there is a need to detect seasonal items so they can be marketed before the season is over and wasted (e.g., sold at deep discount). Conventionally, seasonal items can be marked as such manually in the item catalog database, but this is unreliable and inefficient. However, there is a technical problem of how to automatically, reliably, and at a large enough scale as required by the online system detect seasonal items and mark the seasonal items at the item catalog database.

### SUMMARY

Embodiments of the present disclosure are directed to training a machine-learning model of an online system (e.g., online concierge system) to detect seasonal items from an item catalog database maintained by the online system.

In accordance with one or more aspects of the disclosure, the online system acquires item data with information about an item in an item catalog database stored at one or more non-transitory computer-readable media of the online system. The online system accesses a seasonality prediction model of the online system, wherein the seasonality prediction model is trained to predict a seasonality of the item. The online system applies the seasonality prediction model to output, based at least in part on the item data, a seasonality score for the item that is indicative of the predicted seasonality and identify, based at least in part on the item data, a season associated with the item. The online system updates the item catalog database by adding an identification of the identified season to an entry of the item in the item catalog database. The online system generates, based at least in part on the seasonality score for the item and the identified season, action data associated with one or more actions in relation to the item. The online system communicates, to a computing system of a retailer associated with the online system and via a network, the action data prompting the one or more actions in relation to the item.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example smart shopping cart associated with an online concierge system, in accordance with one or more embodiments.

FIG. 4 illustrates an example architectural flow diagram of using a trained model to detect seasonal items in an item catalog database of an online concierge system, in accordance with one or more embodiments.

FIG. 5 is a flowchart for a method of using a trained model of an online concierge system to detect seasonal items in an item catalog database of the online concierge system, in accordance with one or more embodiments.

### DETAILED DESCRIPTION

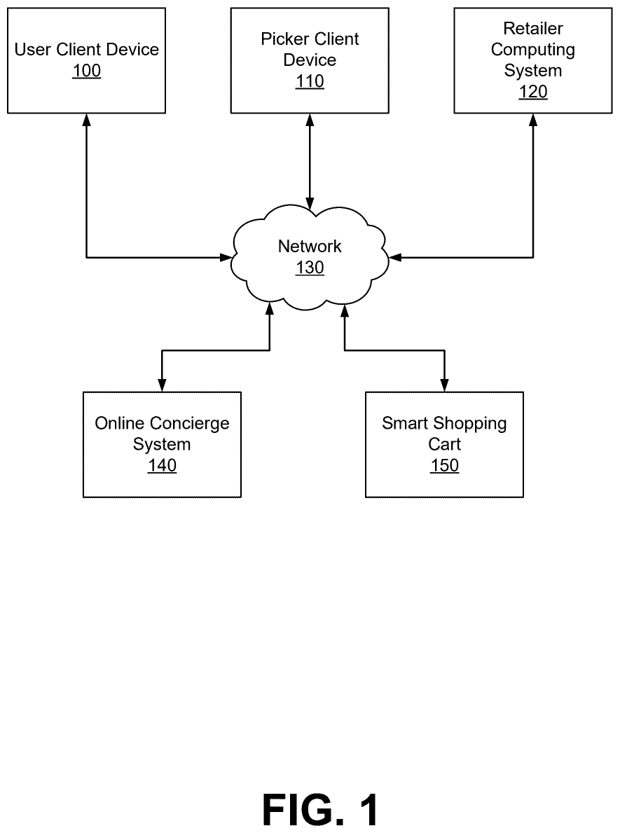

FIG. 1 illustrates an example system environment for an online concierge system 140, in accordance with one or more embodiments. The system environment illustrated in FIG. 1 includes a user client device 100, a picker client device 110, a retailer computing system 120, a network 130, an online concierge system 140, and a smart shopping cart 150. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 sells a catalog database of items, which includes seasonal items that cannot sell or sell at a deep discount after the season is over. To detect which items are seasonal, and what the corresponding seasons are, the online concierge system 140 trains a classifier model (e.g., machine-learning model) to predict whether an item is a seasonal item. Hence, the classifier model is trained to detect the seasonal items in the item catalog database. The timing of the season can be determined from the sales volume of items that are classified as seasonal items. The online concierge system 140 may then label each seasonal item in the item catalog database with a corresponding holiday or season. The classifier model of the online concierge system 140 can be also trained to automatically detect new seasonal items (i.e., seasonal items that are new on market and were never sold before) and associate them with specific holidays or seasons. For each seasonal item, the online concierge system 140 may further determine a price sensitivity score that is indicative of an amount (or percentage) of price drop when the item goes out of season. Additionally, the online concierge system 140 may identify how easily swappable the seasonal items are. Furthermore, by automatically detecting and labeling seasonal items, the online concierge system 140 presented herein can help retailers optimize their merchandising and clear out their stock (or restock low items) as the holiday approaches.

The classifier model of the online concierge system 140 is trained to detect seasonal items and associate them with a particular season or holiday. To identify seasonal items that have been stocked several years in the past, the trained classifier model may utilize information about availability of these items throughout the years, sales rates, found rates, their prices, etc. The classifier model may be trained to identify those items as seasonal items that have a disproportionate amount of their sales in, e.g., a month or two out of the year. The information about availability of items may be provided by an availability model (e.g., machine-learning model) of the online concierge system 140 that is trained to identify a time an item would be restocked, i.e., a time during a particular season when the item would go from “out-of-stock” to “back-in-stock.” This information may help the classifier model tying a seasonal item with a specific season or holiday. For example, a Christmas decoration might still be in stock for a week after Christmas, but it definitely would not get restocked after Christmas.

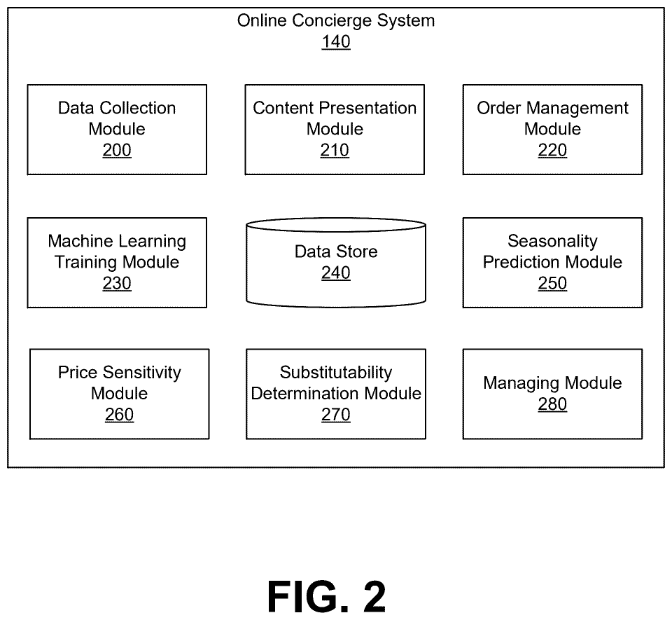

The online concierge system 140 may further deploy another trained model (e.g., machine-learning model) to determine seasonal price sensitivity, i.e., how heavily a seasonal item gets discounted after the holiday is over. As prices changes immediately before and after holiday dates, in addition to tying a seasonal item with the specific holiday date, this information is also indicative of how well the seasonal item retains its value after the holiday is over. For example, the steeper the price discount is, the less confident the retailer is that they can sell that item at full price after the season or holiday is over. The online concierge system 140 is described in further detail below with regards to FIG. 2.

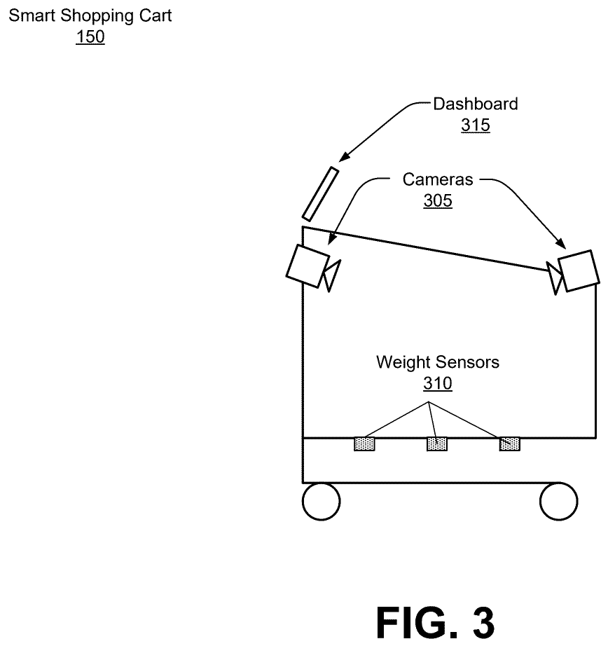

The smart shopping cart 150 is an in-store shopping cart that enables a user of the online concierge system 140 to physically add (i.e., place) items from a location of a retailer (e.g., store) into the smart shopping cart 150 and check the items out from the location of the retailer without an involvement of an employee of the retailer at the point of sale. The smart shopping cart 150 may be connected to the online concierge system 140 via the network 130. During the user's shopping session, the smart shopping cart 150 may utilize various sensors (e.g., one or more weight sensors, one or more cameras, etc.) to gather data about the user's activity, including, but not limited to, a location of the smart shopping cart 150 in the store, weight changes of the smart shopping cart 150 as items are added to or removed from the smart shopping cart 150, video of the user's activity in and around the smart shopping cart 150, images of items added to the smart shopping cart 150, video and/or images of shelfs with items in the store, etc. In one or more embodiments, the smart shopping cart 150 is considered being a part of the online concierge system 140. It should be noted that the concepts described herein in relation to the smart shopping cart 150 can be extended and/or applied to other form factors, such as a handheld shopping basket, a handheld receptacle, or some other handheld object that can be used to receive and store shopping items. The smart shopping cart 150 is described in further detail below with regards to FIG. 3.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a seasonality prediction module 250, a price sensitivity module 260, a substitutability determination module 270, and a managing module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The seasonality prediction module 250 may identify seasonal items within an item catalog database maintained at, e.g., the data store 240. In one or more embodiments, the seasonality prediction module 250 may access a seasonality prediction model (e.g., machine-learning model) that is trained to predict a seasonality of each item within the item catalog database. The seasonality prediction module 250 may deploy the seasonality prediction model to run a machine-learning algorithm to output, based on a set of inputs, a seasonality score for each item (e.g., value between 0 and 1) that is indicative of an item's predicted seasonality. A higher value of the seasonality score may be indicative of a higher level of seasonality, and vice versa for a lower value of the seasonality score. The seasonality score output by the seasonality prediction model may be compared with a threshold score (e.g., 0.5), and an item having the seasonality score higher than the threshold score may be identified as a seasonal item. The seasonality prediction model may be implemented as a classifier model that outputs a seasonality score for an item that represents a classifier indicating whether the item is a seasonal item. A set of parameters for the seasonality prediction model may be stored at one or more non-transitory computer-readable media of the seasonality prediction module 250. Alternatively, the set of parameters for the seasonality prediction model may be stored at one or more non-transitory computer-readable media of the data store 240.

The seasonality prediction module 250 may provide the set of inputs representing various input features to the seasonality prediction model. In providing the set of inputs to the seasonality prediction model, the seasonality prediction module 250 may provide data with information about sales history for an item over a defined time period (e.g., year, two years, etc.), pricing history for the item over the defined time period, availability (or out-of-stock) status for the item over the defined time period, images for the item with information about name(s) and/or ingredient(s) of the item, some other item related data, or some combination thereof. In one or more embodiments, images of the item, information about out-of-stock to back-in-stock status for the item, pricing of the item over time, etc. may be captured over time via cameras of picker client devices 110 and/or cameras or other sensors of smart shopping carts 150. The online concierge system 140 may then receive the captured data from the picker client devices 110 and/or the smart shopping carts 150 via the network 130 and store the received data at the item catalog database maintained at, e.g., the data store 240. The seasonality prediction module 250 may then retrieve the item related data from the item catalog database.

FIG. 3 illustrates an example smart shopping cart 150 associated with the online concierge system 140, in accordance with one or more embodiments. The smart shopping cart 150 may have one or more cameras 305 that collect video data and/or image data in relation to shelfs (i.e., store aisles) with various stored items as a user that utilizes the smart shopping cart 150 for in-store shopping is passing by. The one or more cameras 305 may further collect video data and/or image data in relation to items placed in the smart shopping cart 150, such as a weight of each item as indicated in an item label, a brand of each item, a name of each item, a price of each item, etc. Additionally, the one or more cameras 305 may collect video data and/or image data in relation to actions in and around the smart shopping cart 150, such as a location of the smart shopping cart 150 in a store (e.g., at a location of the retailer) when a certain action occurs (e.g., when an item is added to the cart), user's gestures when placing items in the smart shopping cart 150, video and/or images of user's interactions with the smart shopping cart 150, track the location of the user within the store, measure a velocity of the smart shopping cart 150 in the store, etc. Alternatively or additionally, the smart shopping cart 150 may be equipped with one or more weight sensors 310 that measure weights of items placed in the smart shopping cart 150. The smart shopping cart 150 may further include a dashboard 315 that operates as a user interface that displays a list of items added to a receptacle of the smart shopping cart 150 and can be used for the checkout. The dashboard 315 may be further used for providing notifications to the user that utilizes the smart shopping cart 150 for in-store shopping. The smart shopping cart 150 may include additional sensors not shown in FIG. 3. The dashboard 315 or some other component of the smart shopping cart 150 may further include a computing system that is in communication with the user client device 100, the retailer computing system 120 and/or the online concierge system 140 via the network 130. Data gathered by various sensors of the smart shopping cart 150 may be uploaded via the network 130 at the online concierge system 140 to be stored at the data store 240 and later retrieved as inputs for the seasonality prediction model. Alternatively or additionally, data gathered by various sensors of the smart shopping cart 150 may be uploaded via the network 130 directly to the seasonality prediction module 250 and provided as inputs to the seasonality prediction model.

In one or more embodiments, the seasonality prediction model is trained to identify new seasonal items, i.e., items that have shown up a current season and no past sales data are thus available, but these items are likely tied to a particular season or holiday. In such cases, the seasonality prediction module 250 may provide various item features to the seasonality prediction model, such as item names, descriptions, taxonomy categories, the date an item first becomes available, and early sales data, etc. to identify items that appear to be similar to the seasonal items already identified by the seasonality prediction model.

In one or more embodiments, instead of deploying the seasonality prediction model, the seasonality prediction module 250 applies a set of rules to determine whether an item from an item catalog database is a seasonal item. In such cases, the seasonality prediction module 250 may apply a set of heuristics on various item related data, such as historic price drops for the item, historic trends of out-of-stock status for the item, etc. The seasonality prediction module 250 may then compare outputs of the applied set of heuristics to thresholds in order to determine whether the item is a seasonal item.

Once an item is identified as a seasonal item, the seasonality prediction module 250 may label that seasonal item in the item catalog database with an identifier of a corresponding holiday or season associated with that seasonal item. In one or more embodiments, the seasonality prediction module 250 applies the seasonality prediction model implemented as a multitask classier that outputs, for a given item, a seasonality score for each season and holiday. Then, a highest seasonality score among all seasonality scores across seasons and holidays may identify a holiday or season associated with the item. Alternatively, the seasonality prediction module 250 may apply a set of rules to determine a holiday or season associated with a seasonal item. For example, after the item is declared to be a seasonal item, the seasonality prediction module 250 may apply the set of rules on data with information about timing of price drop, timing of out-of-stock status, etc. to identify a holiday or season associated with this seasonal item. Once the holiday or season associated with the item is identified, the seasonality prediction module 250 may update the item catalog database by adding a label of a corresponding season to the item's entry in the item catalog database.

Once an item is identified as a seasonal item (e.g., via the seasonality prediction module 250), the price sensitivity module 260 may determine a price sensitivity score for the seasonal item. The price sensitivity score is an indication of the price drop when the item goes out of season (e.g., percentage of discount when the item is out of season). In one or more embodiments, to determine the price sensitivity score for a seasonal item, the price sensitivity module 260 applies a set of heuristics on data with information about an average price for the item during a seasonal period and an average price after the seasonal period ends.

In one or more other embodiments, the price sensitivity module 260 accesses a price sensitivity model (e.g., machine-learning model) that is trained to predict a price sensitivity of an item. In such cases, the price sensitivity module 260 may deploy the price sensitivity model to run a machine-learning algorithm to output, based on a set of features for the item, a price sensitivity score for the item that is indicative of the predicted item's price sensitivity (e.g., percentage of discount when the item is out of season). A set of parameters for the price sensitivity model may be stored at one or more non-transitory computer-readable media of the price sensitivity module 260. Alternatively, the set of parameters for the price sensitivity model may be stored at one or more non-transitory computer-readable media of the data store 240.

In providing the set of features for the item to the price sensitivity model, the price sensitivity module 260 may provide information about historic pricing for the item, a name of the item, a set of ingredients for the item, a brand associated with the item, etc. The price sensitivity model may be trained (e.g., via the machine-learning training module 230) to predict a price sensitivity score for an item using a set of observed and/or computed price sensitivity scores for a set of items in the item catalog database. Once trained, the price sensitivity module 260 may apply the price sensitivity model to predict a price sensitivity score for a new item for which historic pricing information is not available.

The price sensitivity score may be specifically useful to determine which items the retailer may not want to tie up in holiday packaging. If the item price drops substantially after the holiday and the item is easily substitutable (e.g., holiday chocolate balls), the retailer may want to stay away from promoting the item in holiday packaging as users are less likely to buy this item either because of the packaging or the idea it is “stale” because it is passed the holiday.

The substitutability determination module 270 may determine a substitutability score for a previously identified seasonal item. The substitutability score (e.g., value between 0 and 1) may be indicative of how easily a substitute for the seasonal item can be found if the seasonal item is out-of-stock. A higher value of the substitutability score may be indicative of higher substitutability for the seasonal item (i.e., the seasonal item is more easily replaceable), and vice versa for a lower value of the substitutability score. To generate the substitutability score for the seasonal item, the substitutability determination module 270 may utilize historical order data associated with the seasonal item to determine how frequently this seasonal item is successfully replaced with one or more other items that are generally not seasonal items.

In summary, for a given item, the online concierge system 140 may apply the seasonality prediction module 250, the price sensitivity module 260 and/or the substitutability determination module 270 to identify a holiday or season the item is tied to, generate a “seasonality score” for the item that is indicative of how concentrated the purchases are in the run-up to that holiday as opposed to being year round, generate a “price sensitivity score for the item that is indicative of an amount (or percentage) the price for the item drops after the holiday is over, and/or a “substitutability score” for the item that is indicative of how easily a substitute for the item can be found if the item is out-of-stock. For example, Christmas ornaments are very seasonal items, Halloween decorations are very seasonal items, eggnog is a less seasonal item, Easter mini eggs are less seasonal items, certain Halloween types of candy are somewhat seasonal items as they are available year-round but sell more in October, etc.

The machine-learning training module 230 may perform initial training of the seasonality prediction model using training data. The machine-learning training module 230 may generate the training data by collecting hand-labeled data of what items are seasonal items. Additionally or alternatively, the machine-learning training module 230 may generate the training data by retrieving retailer-curated seasonal collections from an item catalog database (e.g., at the data store 240). Additionally or alternatively, for training the seasonality prediction model to identify whether a new item is a seasonal item, the machine-learning training model 230 may obtain training data from the heuristics-based approach applied by the seasonality prediction module 250 for predicting whether the new item is a seasonal item. The machine-learning training module 230 may train the seasonality prediction model using the training data to generate initial values for the set of parameters of the seasonality prediction model.

The machine-learning training module 230 may collect feedback data with information from a retailer associated with the online concierge system 140 about whether a particular item is a seasonal item, information about new sales data for the item, etc. For re-training the seasonality prediction model to identify new seasonal items, the machine-learning training module 230 may collect feedback data from two feedback sources. First, the machine-learning training module 230 may collect the sales data over time, in particular information on whether the seasonality spike that was predicted for a new item was actually materialized. Second, the machine-learning training module 230 may collect feedback from the retailer, such as feedback that an item is not actually a seasonal item. The machine-learning training module 230 may then re-train the seasonality prediction model by updating the set of parameters of the seasonality prediction model using the collected feedback data.

Based on the seasonality score for the item, the season or holiday associated with the item, the price sensitivity score for the item and/or the substitutability score for the item, the managing module 280 may trigger one or more actions in relation to the item. In particular, based on the prediction of a sharp drop-off in demand and price of the item, the managing module 280 may trigger the one or more actions related to: merchandising the item (e.g., guidance for the retailer of what and when to promote in relation to the item), managing an inventory of the item (e.g., by providing insights to the retailers about stocking and re-stocking of the item), managing pricing of the item, some other action, or some combination thereof.

In relation to merchandising, retailers typically put a large effort into creating seasonal collections online to highlight all of their holiday items (e.g., Christmas items) together. The item collection database maintained at the data store 240 and updated as presented herein with information about a season or holiday associated with each seasonal item in the item collection database can be utilized to auto-create item lists that the retailers can use to prepopulate their seasonal collections. Additionally, the auto-created item lists can be edited by the retailers such that they can flag items that are not actually seasonal, which would be fed back to the online concierge system 140 and used for re-training of the seasonality prediction module.

For retailers who send to the online concierge system 140 balance-on-hand data, the seasonality data obtained by the online concierge system 140 may be combined with outputs of the availability models (e.g., machine-learning models) to help provide stock predictions in relation to seasonal items. For example, the seasonality data obtained by the online concierge system 140 may help identifying the items that are most likely to go out-of-stock before the specific holiday. In such cases, the managing module 280 may generate a restocking recommendation for specific seasonal items and communicate the restocking recommendation to the retailer computing system 120 via the network 130. In particular, the less substitutable an item is (e.g., a substitutability score for the item as determined by the substitutability determination module 270 is less than a threshold score), the stronger is the restock recommendation generated by the managing module 280. Also, the managing module 280 may generate a recommendation that the retailer does not purchase as many “substitutable” holiday items if they have extra holiday specific branding. For example, chocolate balls may come in holiday wrapping. However, one can just as simply buy chocolate balls not in holiday wrapping as a substitute, and the holiday wrapped chocolate balls may be less likely to sell post-holiday given the holiday branding or people think they are stale, etc. The managing module 280 may then generate a recommendation signal for the retailer computing system 120 suggesting that the retailer order less of these holiday items as they are easily substituted.

The online concierge system 140 presented herein may automatically identify items that are most likely to have excess stock after the holiday (e.g., items with high substitutability scores that are easily substituted). In such cases, the managing module 280 may generate a recommendation signal for the retailer computing system 120 suggesting that the retailer conduct additional online merchandising or perform sales for these particular items. If an item has a high price sensitivity score (i.e., price of the item would drop precipitously after the holiday) or a higher seasonality score (i.e., sales of the item would drop precipitously after the holiday), the recommendation generated by the managing module 280 may be strengthened.

Furthermore, the online concierge system 140 may leverage pickers to reduce wastage and increase the efficiency of retailers' holiday ordering. By having the pickers capture imagery of items and by leveraging data they collect when they refill consumer packaged goods (CPG) end caps and holiday displays, the online concierge system 140 may in real time promote these items on an omni channel of the online concierge system 140 based upon how much the seasonality prediction model and/or the price sensitivity model predict would be left over after the holiday. This could be combined with generating real time incentives for users of the online concierge system 140 to purchase these items, or by presenting the retailer with insights of when to offer more generous incentives such that they clear out their holiday items efficiently prior to, or just after, the holiday occurring. For example, the pickers are continually taking pictures and stock counts on end caps up until the date of Christmas. If it is noticed that holiday chocolate balls were not selling well and they were easily substitutable afterwards, the managing module 280 may recommend the retailer offer steep price discounts the day or two before Christmas, along with promoting these items on user interfaces of user client devices 100 more prominently (e.g., combined with bumping them up as bundles or upsell items) so that users are more likely to choose these items prior to checkout.

The managing module 280 may further provide retailers (e.g., via communication signals sent to the retailer computing device 120 via the network) with information on holiday favorites they might have missed-either items that are identified as having seasonal demand, or items that are bought alongside holiday items. The retailers can then use this information to market these items alongside their other seasonal merchandise. In particular, the online concierge system 140 may find new “coupling” of items for holidays if it is noticed that two items are often bought together and one of which is a seasonal item as identified by the seasonality prediction model. For example, if a user of the online concierge system 140 buys candy canes and also chocolate marshmallows together during the Christmas season, then chocolate marshmallows can be promoted as a Christmas related item.

While popup seasonal clear-out sections are commonplace in store, there has never been an easy way to create the clear-out sections online such that the online concierge system 140 can leverage them on its omnichannel. By making use of pickers in the store, the pickers can take pictures of the seasonal clear-out sections in the store which will directly translate to auto-creating seasonal clear-out categories in the item catalog database of the online concierge system 140. The seasonal clear-out categories can be also seasonal clear-out categories not just from the picker photos, but also from data within the item catalog database that label precipitous price drops for certain taxonomies or certain items.

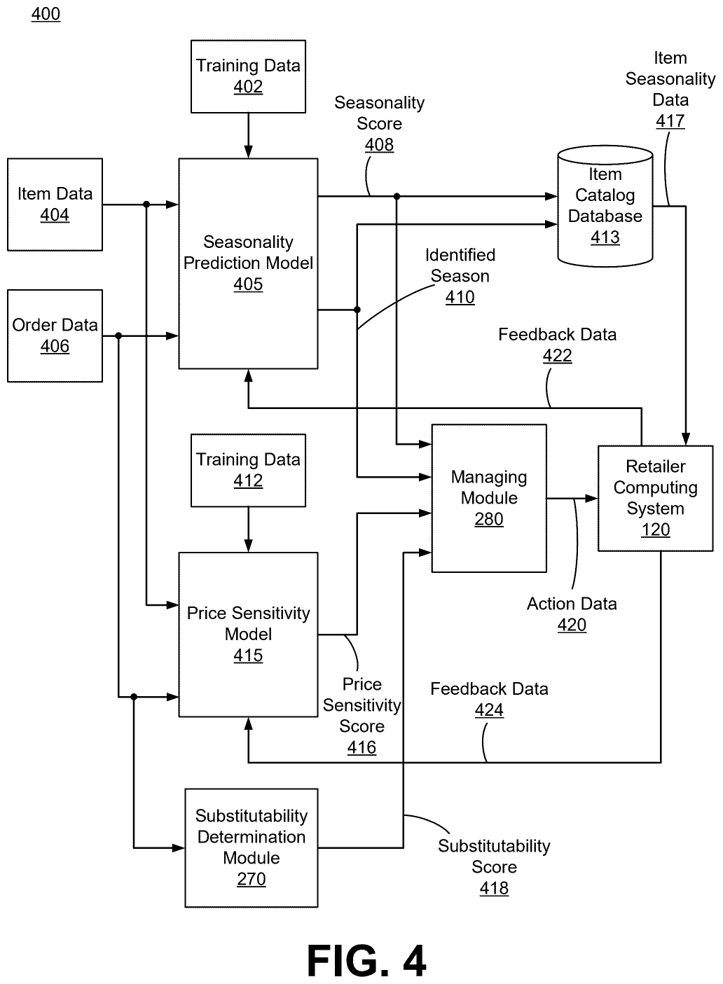

FIG. 4 illustrates an example architectural flow diagram 400 of using a seasonality prediction model 405 to detect seasonal items in an item catalog database (e.g., at the data store 240) of the online concierge system 140, in accordance with one or more embodiments. First, the online concierge system 140 may perform (e.g., via the machine-learning training module 230) initial training of the seasonality prediction model 405 using training data 402 to generate initial values for the set of parameters of the seasonality prediction model 405. The training data 402 may be generated (e.g., via the machine-learning training module 230) by collecting hand-labeled data of what items are seasonal items, retrieving retailer-curated seasonal collections from an item catalog database 413, and/or by collecting data generated by the heuristics-based approach applied by the seasonality predict module 250 for predicting whether a new item is a seasonal item. After the training process is completed, the online concierge system 140 may provide different inputs to the seasonality prediction model 405 (e.g., via the seasonality prediction module 250), such as item data 304 and order data 306. Some additional input data not shown in FIG. 4 suitable for predicting a seasonality of an item may be further provided to the seasonality prediction model 405.

In providing the item data 404 to the seasonality prediction model 405, the online concierge system 140 may provide (e.g., via the seasonality prediction module 250) information about pricing history for an item (e.g., the item in the item catalog database 413) over a defined time period (e.g., year, two years, etc.), availability (or out-of-stock) status for the item over the defined time period, images for the item with information about name(s) of the item and/or ingredient(s) of the item, some other item related data, or some combination thereof. At least some portion of the item data 404 may be captured via cameras of picker client devices 110 and/or cameras or other sensors of smart shopping carts 150 over the defined time period, received at the online concierge system 140 and stored in the item catalog database 413 or some other database of e.g., the data store 240. The seasonality prediction module 250 may then retrieve the item data 404 from the item catalog database 413 or some other database of the data store 240.

In providing the order data 406 to the seasonality prediction model 405, the online concierge system 140 may provide (e.g., via the seasonality prediction module 250) information about sales history for the item over a defined time period (e.g., year, two years, etc.). The online concierge system 140 may receive the order data 406 from one or more user client devices 100 and/or one or more retailer computing systems 120 via the network 130 over the defined time period and store the received order data 406 in the item catalog database 413 or some other database of e.g., the data store 240. The seasonality prediction module 250 may then retrieve the order data 406 from the item catalog database 413 or some other database of the data store 240.

The seasonality prediction model 405 may apply a classifier-based machine-learning algorithm to the item data 404 and the order data 406 to output a seasonality score 408 for the item that is indicative of a seasonality feature of the item. A higher value of the seasonality score may be indicative of a higher level of seasonality, and vice versa. The seasonality score 408 may be compared with a threshold score (e.g., 0.5), and an item having the seasonality score 408 higher than the threshold score may be identified as a seasonal item. Alternatively, the seasonality prediction model 405 may operate as a multitask classifier that outputs multiple seasonality scores 408 for the item where each seasonality score 408 is associated with a corresponding season or holiday. Then, the highest value of the seasonality score 408 among all seasonality scores may be considered as one that is indicative of a seasonality feature of the item. The highest value of the seasonality score 408 may also identify a season that is associated with the item, i.e., an identified season 410. Alternatively, the seasonality prediction model 405 may output, based on the item data 404 and/or the order data 406, a single label that represents the identified season 410. The seasonality prediction model 405 (or the seasonality prediction module 250) may update the item catalog database 413 such that the seasonality score 408 and/or a label of the identified season 410 are added to a corresponding entry of the item in the item catalog database 413. Additionally, the seasonality prediction model 405 may pass the seasonality score 408 and the label of the identified season 410 to the managing module 280.

The item data 404 and/or the order data 406 may be further utilized as input features provided to a price sensitivity model 415. Before applying the price sensitivity model 415, the online concierge system 140 may perform (e.g., via the machine-learning training module 230) initial training of the price sensitivity model 415 using training data 412 to generate initial values for the set of parameters of the price sensitivity model 415. The training data 412 may be generated (e.g., via the machine-learning training module 230) by retrieving a set of observed price sensitivity features for a set of items in the item catalog database 413 or some other database of the data store 240. After the training, the price sensitivity model 415 may apply a machine-learning algorithm to the item data 404 and/or the order data 406 to output a price sensitivity score 416 for the item that is indicative of a price sensitivity of the item. Note that, at this point, the item has already been identified as a seasonal item by the seasonality prediction model 405. The price sensitivity model 415 may pass the price sensitivity score 416 to the managing module 280. Additionally, the price sensitivity model 415 (or the price sensitivity module 260) may update the item catalog database 413 such that the price sensitivity score 416 is added to a corresponding entry of the item in the item catalog database 413.

The substitutability determination module 270 may determine, based on at least a portion of the order data 406 (e.g., historical order data including replacement data for the item), a substitutability score 418 for the item that has already been identified as a seasonal item by the seasonality prediction model 405. The substitutability score 418 (e.g., value between 0 and 1) may be indicative of how easily a substitute for the seasonal item can be found if the seasonal item is out-of-stock. A higher value of the substitutability score 418 may be indicative of higher substitutability for the seasonal item (i.e., the seasonal item is more easily replaceable), and vice versa. The substitutability determination module 270 may pass the substitutability score 418 to the managing module 280. Additionally, the substitutability determination module 270 may update the item catalog database 413 such that the substitutability score 418 is added to a corresponding entry of the item in the item catalog database 413.

The managing module 280 may generate, based on the seasonality score 408, the label of the identified season 410, the price sensitivity score 416 and/or the substitutability score 418, action data 420. The action data 420 may be digital signals that identify one or more actions in relation to the seasonal item, such as merchandising of the seasonal item, managing an inventory of the seasonal item, some other action, or some combination thereof. The managing module 280 may communicate the action data 420 to the retailer computing system 120 via the network 130. Upon reception of the action data 420 at the retailer computing system 120, a retailer associated with the online concierge system 140 may be prompted to perform the one or more actions identified by the action data 420, e.g., merchandising the item, managing an inventory of the item, etc. Additionally or alternatively, the retailer computing system 120 may retrieve, from the item catalog database 413, item seasonality data 417 for the item with information about the seasonality score 408, the label of the identified season 410, the price sensitivity score 416 and/or the substitutability score 418 for the item. Based on the retrieved item seasonality data 417, the retailer may be prompted to perform one or more actions in relation to the item, such as merchandising the item, managing an inventory of the item, some other action, or some combination thereof.

The retailer computing system 120 may provide feedback data 422 with information about sales data for the item over a particular time period (e.g., time period that encompasses the identified season or holiday) and/or explicit feedback from the retailer about a seasonality of the item. The machine-learning training module 230 may utilize the feedback data 422 to re-train the seasonality prediction model 405. By utilizing the feedback data 422, the machine-learning training module 230 may update the set of parameters of the seasonality prediction model 405, and continuously improve the machine-learning algorithm of the seasonality prediction model 405. Additionally, the retailer computing system 120 may provide feedback data 424 with pricing information about the item over a particular time period (e.g., time period that encompasses the identified season or holiday). The machine-learning training module 230 may utilize the feedback data 424 to re-train the price sensitivity model 415. By utilizing the feedback data 424, the machine-learning training module 230 may update the set of parameters of the price sensitivity model 415, and continuously improve the machine-learning algorithm of the price sensitivity model 415.

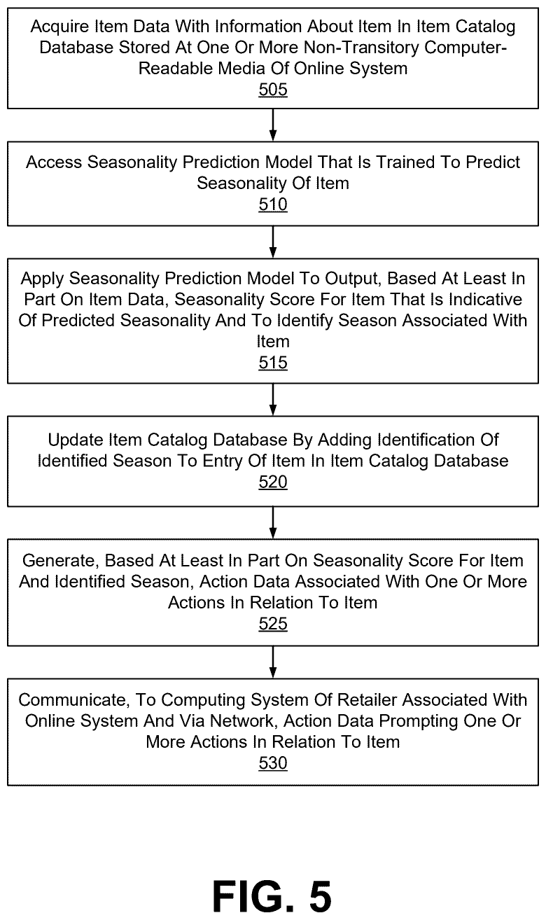

FIG. 5 is a flowchart for a method of using a trained model of an online concierge system to detect seasonal items in an item catalog database of the online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 acquires 505 (e.g., via the seasonality prediction module 250) item data with information about an item in an item catalog database stored at one or more non-transitory computer-readable media of online concierge system 140 (e.g., at the data store 240). The online concierge system 140 may receive (e.g., via the data collection module 200), via a network (e.g., the network 130) from one or more devices of one or more pickers associated with the online concierge system 140 (e.g., one or more picker client devices 110), the item data including at least one of one or more images of the item, information about availability of the item over a defined time period (e.g., year, several years, etc.), or information about a price of the item over the defined time period.

Alternatively or additionally, the online concierge system 140 may receive (e.g., via the data collection module 200), via the network from one or more computing systems mounted to one or more physical receptacles (e.g., smart shopping carts 150) utilized for shopping at one or more locations of the retailer, the item data including at least one of one or more images of the item, information about availability of the item over the defined time period, or information about a price of the item over the defined time period. Alternatively or additionally, the online concierge system 140 may receive (e.g., via the data collection module 200), via the network from one or more devices associated with one or more user of the online concierge system 140 (e.g., one or more user client devices 100), the item data with information about conversion of the item over the defined time period by the one or more users. The online concierge system 140 may store (e.g., via the data collection module 200) the received item data at a database of the online concierge system 140 (e.g., the data store 240). The online concierge system 140 may retrieve (e.g., via the seasonality prediction module 250) the stored item data from the database.

The online concierge system 140 accesses 510 a seasonality prediction model of the online concierge system 140 (e.g., via the seasonality prediction module 250), wherein the seasonality prediction model is trained to predict a seasonality of the item. The online concierge system 140 applies 515 the seasonality prediction model (e.g., via the seasonality prediction module 250) to output, based at least in part on the item data, a seasonality score for the item that is indicative of the predicted seasonality and identify, based at least in part on the item data, a season (i.e., holiday) associated with the item. The online concierge system 140 updates 520 (e.g., via the seasonality prediction module 250) the item catalog database by adding an identification of the identified season to an entry of the item in the item catalog database.

The online concierge system 140 may collect (e.g., via the machine-learning training module 230) training data including at least one of manually labeled data with information about what items in the item catalog database are seasonal items or retailer-curated seasonal collection data stored at the item catalog database. Alternatively or additionally, the online concierge system 140 may apply (e.g., via the seasonality prediction module 250) a set of heuristics on the item data to output a set of results including a prediction of whether the item is a seasonal item. The online concierge system 140 may then generate (e.g., via the machine-learning training module 230) training data based at least in part on the set of results. The online concierge system 140 may train (e.g., via the machine-learning training module 230), using the training data, the seasonality prediction model to generate a set of initial values for the set of parameters of the seasonality prediction model. The online concierge system 140 may collect (e.g., via the machine-learning training module 230) feedback data with least one of information about conversion of the item over a defined time period (e.g., time of year that at least includes the predicted season or holiday) or feedback from a retailer associated with the online concierge system 140 about the seasonality of the item. The online concierge system 140 may re-train the seasonality prediction model by updating (e.g., via the machine-learning training module 230), using the collected feedback data, the set of parameters of the seasonality prediction model.

The online concierge system 140 may compare (e.g., via the price sensitivity module 260) the seasonality score for the item with a threshold score. Responsive to the seasonality score for the item being greater than the threshold score, the online concierge system 140 may access a price sensitivity model of the online concierge system 140 (e.g., via the price sensitivity module 260), wherein the price sensitivity model is trained to predict a price sensitivity of the item. The online concierge system 140 may apply the price sensitivity model (e.g., via the price sensitivity module 260) to output, based at least in part on the item data, a price sensitivity score for the item that is indicative of the predicted price sensitivity of the item. The online concierge system 140 may obtain (e.g., via the substitutability determination module 270) a historical order data associated with the item. The online concierge system 140 may generate, based at least in part on the historical order data, a substitutability score for the item that is indicative of a substitutability of the item.

The online concierge system 140 may generate training data by retrieving (e.g., via the machine-learning training module 230), from the item catalog database, a set of observed price sensitivity scores for a set of items in the item catalog database. The online concierge system 140 may train (e.g., via the machine-learning training module 230), using the training data, the price sensitivity model to generate a set of initial values for the set of parameters of the price sensitivity model.

The online concierge system 140 generates 525 (e.g., via the managing module 280), based at least in part on the seasonality score for the item and the identified season, action data associated with one or more actions in relation to the item. The online concierge system 140 communicates 530 (e.g., via the managing module 280), to a computing system of a retailer associated with the online concierge system 140 (e.g., the retailer computing system 120) and via a network (e.g., the network 130), the action data prompting the one or more actions in relation to the item. The online concierge system 140 may generate (e.g., via the managing module 280) the action data further based on the price sensitivity score and the substitutability score. The online concierge system 140 may communicate the action data by communicating (e.g., via the managing module 280), to the computing system associated with the retailer and via the network, a recommendation for the retailer about at least one of merchandising the item or managing an inventory of the item. In response to the received recommendation, the retailer computing system 120 may automatically adjust a restocking order associated with the item. Alternatively or additionally, in response to the received recommendation, the retailer computing system 120 may generate an appropriate advertisement for the item.

Embodiments of the present disclosure are directed to the online concierge system 140 that utilizes trained machine-learning models to identify seasonal items and a price sensitivity of the items due to seasonality. Based on the predicted seasonality and price sensitivity, the online concierge system 140 may trigger various actions in relation to the identified seasonal items, such as marketing the seasonal items, managing inventories of the seasonal items, etc.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
acquiring item data with information about an item in an item catalog database stored at one or more non-transitory computer-readable media of an online system;
accessing a seasonality prediction model of the online system, wherein the seasonality prediction model is trained to predict a seasonality of the item;
applying the seasonality prediction model to:
output, based at least in part on the item data, a seasonality score for the item that is indicative of the predicted seasonality, and
identify, based at least in part on the item data, a season associated with the item;
updating the item catalog database by adding an identification of the identified season to an entry of the item in the item catalog database;
generating, based at least in part on the seasonality score for the item and the identified season, action data associated with one or more actions in relation to the item; and
communicating, to a computing system of a retailer associated with the online system and via a network, the action data prompting the one or more actions in relation to the item.

2. The method of claim 1, wherein acquiring the item data comprises:
receiving, via the network from one or more devices of one or more pickers associated with the online system, the item data including at least one of one or more images of the item, information about availability of the item over a defined time period, or information about a price of the item over the defined time period;
storing the received item data at a database of the online system; and
retrieving the stored item data from the database.

3. The method of claim 1, wherein acquiring the item data comprises:
receiving, via the network from one or more computing systems mounted to one or more physical receptacles utilized for shopping at one or more locations of the retailer, the item data including at least one of one or more images of the item, information about availability of the item over a defined time period, or information about a price of the item over the defined time period;
storing the received item data at a database of the online system; and
retrieving the stored item data from the database.

4. The method of claim 1, wherein acquiring the item data comprises:
receiving, via the network from one or more devices associated with one or more user of the online system, the item data with information about conversion of the item over a defined time period by the one or more users;
storing the received item data at a database of the online system; and
retrieving the stored item data from the database.

5. The method of claim 1, further comprising:
collecting training data including at least one of manually labeled data with information about what items in the item catalog database are seasonal items or retailer-curated seasonal collection data stored at the item catalog database; and
training, using the training data, the seasonality prediction model to generate a set of initial values for a set of parameters of the seasonality prediction model.

6. The method of claim 1, further comprising:
applying a set of heuristics on the item data to output a set of results including a prediction of whether the item is a seasonal item;
generating training data based at least in part on the set of results; and
training, using the training data, the seasonality prediction model to generate a set of initial values for a set of parameters of the seasonality prediction model.

7. The method of claim 1, further comprising:
collecting feedback data with least one of information about conversion of the item over a defined time period or feedback from the retailer about the seasonality of the item; and
re-training the seasonality prediction model by updating, using the collected feedback data, a set of parameters of the seasonality prediction model.

8. The method of claim 1, further comprising:
comparing the seasonality score for the item with a threshold score;
responsive to the seasonality score for the item being greater than the threshold score, accessing a price sensitivity model of the online system, wherein the price sensitivity model is trained to predict a price sensitivity of the item; and
applying the price sensitivity model to output, based at least in part on the item data, a price sensitivity score for the item that is indicative of the predicted price sensitivity of the item.

9. The method of claim 8, further comprising:
generating training data by retrieving, from the item catalog database, a set of observed price sensitivity scores for a set of items in the item catalog database; and
training, using the training data, the price sensitivity model to generate a set of initial values for a set of parameters of the price sensitivity model.

10. The method of claim 8, further comprising:
obtaining historical order data associated with the item; and
generating, based at least in part on the historical order data, a substitutability score for the item that is indicative of a substitutability of the item.

11. The method of claim 10, wherein:
generating the action data comprises generating, further based on the price sensitivity score and the substitutability score, the action data; and
communicating the action data comprises communicating, to the computing system associated with the retailer and via the network, a recommendation for the retailer about at least one of merchandising the item or managing an inventory of the item.

12. A computer program product comprising a non-transitory computer readable storage medium having instructions encoded thereon that, when executed by a processor, cause the processor to perform steps comprising:
acquiring item data with information about an item in an item catalog database stored at one or more non-transitory computer-readable media of an online system;
accessing a seasonality prediction model of the online system, wherein the seasonality prediction model is trained to predict a seasonality of the item;
applying the seasonality prediction model to:
output, based at least in part on the item data, a seasonality score for the item that is indicative of the predicted seasonality, and
identify, based at least in part on the item data, a season associated with the item;
updating the item catalog database by adding an identification of the identified season to an entry of the item in the item catalog database;
generating, based at least in part on the seasonality score for the item and the identified season, action data associated with one or more actions in relation to the item; and
communicating, to a computing system of a retailer associated with the online system and via a network, the action data prompting the one or more actions in relation to the item.

13. The computer program product of claim 12, wherein the instructions further cause the processor to perform steps comprising:
receiving, via the network from one or more devices of one or more pickers associated with the online system, the item data including at least one of one or more images of the item, information about availability of the item over a defined time period, or information about a price of the item over the defined time period;
storing the received item data at a database of the online system; and
retrieving the stored item data from the database.

14. The computer program product of claim 12, wherein the instructions further cause the processor to perform steps comprising:
receiving, via the network from one or more computing systems mounted to one or more physical receptacles utilized for shopping at one or more locations of the retailer, the item data including at least one of one or more images of the item, information about availability of the item over a defined time period, or information about a price of the item over the defined time period;
storing the received item data at a database of the online system; and
retrieving the stored item data from the database.

15. The computer program product of claim 12, wherein the instructions further cause the processor to perform steps comprising:
collecting training data including at least one of manually labeled data with information about what items in the item catalog database are seasonal items or retailer-curated seasonal collection data stored at the item catalog database; and
training, using the training data, the seasonality prediction model to generate a set of initial values for a set of parameters of the seasonality prediction model.

16. The computer program product of claim 12, wherein the instructions further cause the processor to perform steps comprising:
applying a set of heuristics on the item data to output a set of results including a prediction of whether the item is a seasonal item;
generating training data based at least in part on the set of results;
training, using the training data, the seasonality prediction model to generate a set of initial values for a set of parameters of the seasonality prediction model;
collecting feedback data with least one of information about conversion of the item over a defined time period or feedback from the retailer about the seasonality of the item; and
re-training the seasonality prediction model by updating, using the collected feedback data, the set of parameters of the seasonality prediction model.

17. The computer program product of claim 12, wherein the instructions further cause the processor to perform steps comprising:
comparing the seasonality score for the item with a threshold score;
responsive to the seasonality score for the item being greater than the threshold score, accessing a price sensitivity model of the online system, wherein the price sensitivity model is trained to predict a price sensitivity of the item;
applying the price sensitivity model to output, based at least in part on the item data, a price sensitivity score for the item that is indicative of the predicted price sensitivity of the item;
obtaining historical order data associated with the item; and
generating, based at least in part on the historical order data, a substitutability score for the item that is indicative of a substitutability of the item.

18. The computer program product of claim 17, wherein the instructions further cause the processor to perform steps comprising:
generating training data by retrieving, from the item catalog database, a set of observed price sensitivity scores for a set of items in the item catalog database; and
training, using the training data, the price sensitivity model to generate a set of initial values for a set of parameters of the price sensitivity model.

19. The computer program product of claim 17, wherein the instructions further cause the processor to perform steps comprising:
generating the action data, further based on the price sensitivity score and the substitutability score, the action data; and
communicating the action data by communicating, to the computing system associated with the retailer and via the network, a recommendation for the retailer about at least one of merchandising the item or managing an inventory of the item.

20. A computer system comprising:
a processor; and
a non-transitory computer-readable storage medium having instructions that, when executed by the processor, cause the computer system to perform steps comprising:
acquiring item data with information about an item in an item catalog database stored at one or more non-transitory computer-readable media of an online system;
accessing a seasonality prediction model of the online system, wherein the seasonality prediction model is trained to predict a seasonality of the item;
applying the seasonality prediction model to:
output, based at least in part on the item data, a seasonality score for the item that is indicative of the predicted seasonality,
identify, based at least in part on the item data, a season associated with the item;
updating the item catalog database by adding an identification of the identified season to an entry of the item in the item catalog database;
generating, based at least in part on the seasonality score for the item and the identified season, action data associated with one or more actions in relation to the item; and
communicating, to a computing system of a retailer associated with the online system and via a network, the action data prompting the one or more actions in relation to the item.
